(19) United States
(12) Patent Application Publication
(10) Pub. No.: US 2009/0073101 A1
(43) Pub. Date: Mar. 19, 2009

(54) Software driven display restore mechanism

(76) Inventors: William S. Herz, Hayward, CA (US); Gang Han, San Jose, CA (US)

Correspondence Address: MURABITO, HAO & BARNES LLP, Third Floor, Two North Market Street, San Jose, CA, 95113, US

(21) Appl. No.: 11/903,156

(22) Filed: Sep. 19, 2007

(51) Int. Cl. G09G 3/36

(52) U.S. Cl. 345/98

(57) ABSTRACT

A method and system for restoring output to a display device. The method includes receiving a request to restore the output, modifying output settings so output is visible on a display device, and invoking an output configuration application. The method and system allow a user to restore the output on a display device after the output has been configured to settings which exceed the capabilities of the display device.

### CROSS REFERENCE TO RELATED APPLICATION

This application is related to commonly assigned U.S. patent application Ser. No. ______, entitled “HARDWARE DRIVEN DISPLAY RESTORE MECHANISM” by Herz et al., attorney docket number NVID-P003242, which is incorporated herein in its entirety.

### FIELD OF THE INVENTION

The present invention is generally related to hardware graphics systems.

### BACKGROUND OF THE INVENTION

Increasing distribution of digital content has helped the growth of more advanced display technologies such as high definition televisions. At the same time computers have developed an increasing role in entertainment systems and thus connected with high definition devices such as televisions. In order to get the best possible visual experience, the output settings need to match content format and the capabilities of the display device. Therefore, there are times when a user will need to change the resolution of the output or when a new device is connected.

A problem exists however when the user sets output settings (e.g., resolution or refresh rate) beyond the capabilities of a display device. For example, the user may be trying to watch a high definition DVD and sets the display resolution to a “1080p” while the display device (e.g., plasma television) only supports a display resolution up to 720p. Such changes to the display resolution are typically implemented via a television handheld remote control that manipulates one or more on-screen menus (e.g., a menu of options graphically presented on the television screen). Upon pressing the remote control button to select the high-resolution, the user will then be presented with either a blank screen or a corrupted and incomprehensible video signal because the display device is not capable of displaying the input signal provided to it.

Some prior art solutions have attempted to solve this problem (e.g., the user selecting an unsupported display resolution) by waiting for a user to acknowledge that the resolution change worked. If no acknowledgement is received within a defined time out period the resolution is restored to the previous working resolution. Unfortunately, this time out method is not consistently reliable, because depending upon how it is implemented (e.g., set-top box, media center PC, etc.), the timeout function may freeze or stop functioning.

With respect to PC-based systems (e.g., small form factor set-top box PC systems, wired or wirelessly connected PCs, etc.), the software-based functionality (e.g. operating systems) of the systems do not provide even a time out mechanism. In this case, the user will be stuck with the unsupported resolution. For example, the user may be stuck with a blank screen because he/she cannot see an application on screen, control panel menu, or the like to fix the output settings. Being suddenly confronted with a blank screen, the user may also not realize what the mistake was and further be stuck because he/she does not know how to go about fixing the problem. In some instances, the only solution to restore the resolution is to reboot or restart the computer system.

Further, no standard or universal solution has been established for allowing restoration of output to a comprehensible mode. Such a solution would need to be platform or hardware independent. For example, some solutions have required custom hardware in order to restore the output to a comprehensible mode. With the large number of legacy computing systems in use today, a hardware based solution would require upgrades to each system which would quickly become cumbersome and time consuming.

Thus, a need exists for a hardware independent and reliable way for users to restore the resolution so that the output is not left at a resolution unsupported by a display device. The solution should work on the large number of legacy computing systems currently in use. What is further needed is a way to automatically return to a displayable resolution so the user is not presented with a blank screen, and thus no on screen menu or interface that can correct the problem. The required system should be transparent and intuitively comprehended by the user.

### SUMMARY OF THE INVENTION

Embodiments of the present invention provide a hardware independent solution that enables a user to reliably restore the output to settings supported by a display device. Embodiments of the present invention further provide a user with a transparent and intuitively comprehended system for restoring output settings and usability of a display device.

In one embodiment, the present invention is implemented as a method for restoring an output mode of a display output for a display (e.g., LCD display, projection TV display, plasma display, and the like). The method includes receiving a signal to change a resolution of the display output. The display output is provided to the display and is configured to drive the display (e.g., standard definition video output, high definition video output, etc.). Upon receiving the signal, an interrupt is generated for a graphics driver executing on a computer system. The graphics driver is configured to control a graphics processor of the computer system. In response to the interrupt, a control panel application is signaled to modify the output settings to restore a display capable resolution of the display output to a compatible output mode for driving the display. Additionally, a control panel application function is executed on the computer system to present an on-display control for changing the output mode.

In this manner, embodiments of the present invention implement a hardware independent and reliable way for a user to restore a display capable resolution of the display output to a mode that will be supported by the display device. Embodiments of the present invention operate via the operating system and thus do not have specific hardware requirements. The user can be provided with an easy way to generate a signal (e.g., pushing a button on a remote, computer system, etc.) that will automatically initiate the restoration of the display to a compatible resolution, thereby, for example, greatly assisting the user in those circumstances where the user inadvertently changes the output mode of the display output to an unusable output.

In another embodiment, the present invention is implemented as a system for outputting graphics. The system includes a plurality of output connectors (e.g., DVI, VGA, Component, etc.) for coupling a plurality of display devices. The display devices are driven by a display processor (e.g., GPU) for handling graphics processing and outputting a video signal on the plurality of output connectors. The display processor also includes a plurality of connectors. A second processor (e.g., CPU) controls a plurality of functions of the display processor by executing a graphics driver and an application for changing a plurality of graphics settings of the display device. An input device is communicatively coupled to at least one of the plurality of connectors of the display processor and invokes a change in output settings so the output is viewable on at least one of the display devices coupled to the output connectors.

In another embodiment, the present invention is implemented as a graphics processing unit (GPU). The GPU includes a graphics data source for receiving graphics data from a graphics content source and a plurality of outputs operable to drive a plurality of display device(s) with processed graphics data. The system further includes a processor for rendering graphics data and a connector for receiving a signal to restore the output to a compatible output mode. The processor generates an interrupt to facilitate restoration of a render capable resolution in response to the signal received over the connector. In one embodiment, the signal to restore the output to a compatible output mode may be received via a GPIO pin. In another embodiment, the signal to restore the output to a compatible output mode may be received via an application which receives signals from an RF, IR, or the like receiver.

### BRIEF DESCRIPTION OF THE DRAWINGS

The present invention is illustrated by way of example, and not by way of limitation, in the figures of the accompanying drawings and in which like reference numerals refer to similar elements.

FIG. 1 shows a computer system in accordance with one embodiment of the present invention.

FIG. 2 shows a block diagram of an operating environment in accordance with one embodiment of the present invention.

FIG. 3 shows a diagram of a system for restoring output to a display device in accordance with one embodiment of the present invention.

FIG. 4 shows an exemplary graphics processing unit in accordance with one embodiment of the present invention.

FIG. 5 shows a flowchart of a process for modifying output settings so the output is visible on a display device in accordance with one embodiment of the present invention.

FIG. 6 shows a flowchart of a process for operating a system in accordance with one embodiment of the present invention.

### DETAILED DESCRIPTION OF THE INVENTION

Reference will now be made in detail to the preferred embodiments of the present invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of embodiments of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail as not to unnecessarily obscure aspects of the embodiments of the present invention. Notation and Nomenclature:

Some portions of the detailed descriptions, which follow, are presented in terms of procedures, steps, logic blocks, processing, and other symbolic representations of operations on data bits within a computer memory. These descriptions and representations are the means used by those skilled in the data processing arts to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

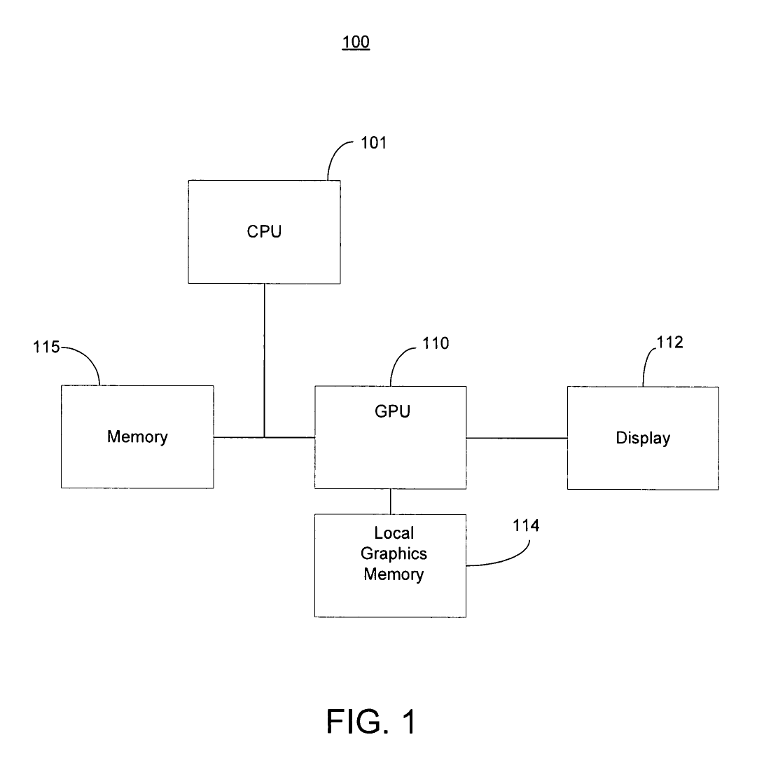

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “accessing” or “executing” or “storing” or “rendering” or the like, refer to the action and processes of a computer system (e.g., computer system 100 of FIG. 1), or similar electronic computing device, that manipulates and transforms data represented as physical (electronic) quantities within the computer system's registers and memories into other data similarly represented as physical quantities within the computer system memories or registers or other such information storage, transmission or display devices.

### Computer System Platform:

FIG. 1 shows a computer system 100 in accordance with one embodiment of the present invention. Computer system 100 depicts the components of a basic computer system in accordance with embodiments of the present invention providing the execution platform for certain hardware-based and software-based functionality. In general, computer system 100 comprises at least one CPU 101, a system memory 115, and at least one graphics processor unit (GPU) 110. The CPU 101 can be coupled to the system memory 115 via a bridge component/memory controller (not shown) or can be directly coupled to the system memory 115 via a memory controller (not shown) internal to the CPU 101. The GPU 110 is coupled to a display 112. One or more additional GPUs can optionally be coupled to system 100 to further increase its computational power. The GPU(s) 110 is coupled to the CPU 101 and the system memory 115. The GPU 110 can be implemented as a discrete component, a discrete graphics card designed to couple to the computer system 100 via a connector (e.g., AGP slot, PCI-Express slot, etc.), a discrete integrated circuit die (e.g., mounted directly on a motherboard), or as an integrated GPU included within the integrated circuit die of a computer system chipset component (not shown). Additionally, a local graphics memory 114 can be included for the GPU 110 for high bandwidth graphics data storage.

The CPU 101 and the GPU 110 can also be integrated into a single integrated circuit die and the CPU and GPU may share various resources, such as instruction logic, buffers, functional units and so on, or separate resources may be provided for graphics and general-purpose operations. The GPU may further be integrated into a core logic component. Accordingly, any or all the circuits and/or functionality described herein as being associated with the GPU 110 can also be implemented in, and performed by, a suitably equipped CPU 101. Additionally, while embodiments herein may make reference to a GPU, it should be noted that the described circuits and/or functionality can also be implemented and other types of processors (e.g., general purpose or other special-purpose coprocessors) or within a CPU.

System 100 can be implemented as, for example, a desktop computer system or server computer system having a powerful general-purpose CPU 101 coupled to a dedicated graphics rendering GPU 110. In such an embodiment, components can be included that add peripheral buses, specialized audio/video components, IO devices, and the like. Similarly, system 100 can be implemented as a handheld device (e.g., cellphone, etc.), direct broadcast satellite (DBS)/terrestrial set-top box or a set-top video game console device such as, for example, the Xbox®, available from Microsoft Corporation of Redmond, Wash., or the PlayStation3®, available from Sony Computer Entertainment Corporation of Tokyo, Japan. System 100 can also be implemented as a “system on a chip”, where the electronics (e.g., the components 101, 115, 110, 114, and the like) of a computing device are wholly contained within a single integrated circuit die. Examples include a hand-held instrument with a display, a car navigation system, a portable entertainment system, and the like.

### Example Operating Environment:

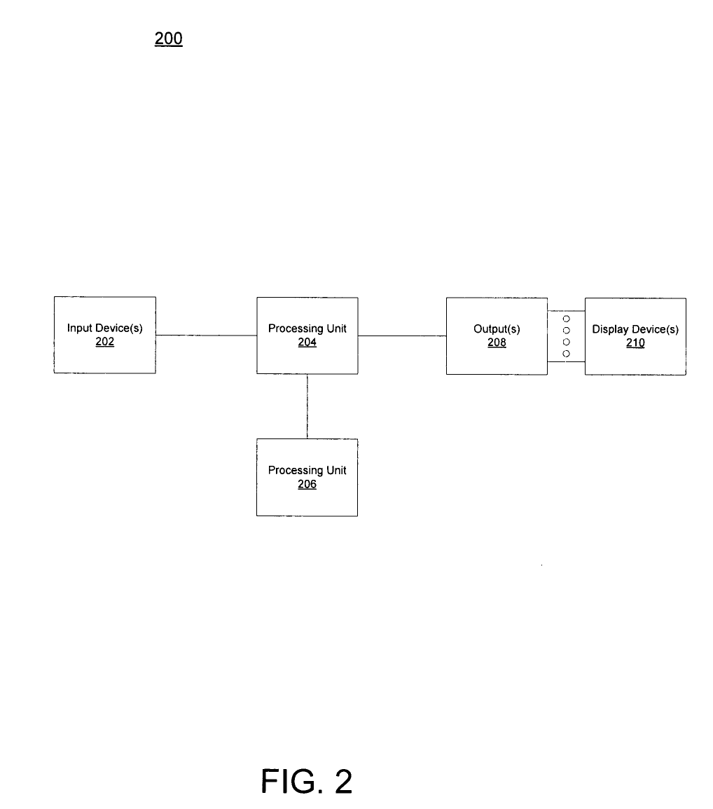

FIG. 2 shows an operating environment of a system 200 in accordance with an embodiment of the present invention. System 200 includes input device(s) 202, processing unit 204, processing unit 206, output(s) 208 and display device(s) 210.

Input device(s) 202 may include devices such as a remote control, an IR receiver device, a RF receiver device, a USB dongle, a button on a system chassis, or the like. Input device(s) 202 may be coupled to processing unit 204 via one or more of a plurality of connectors. In one embodiment, input device(s) 202 may be communicatively coupled to processing unit 204 via a general purpose input output pin or connector. General purpose input output connectors may be used for input in a master mode and output in a slave mode. In another embodiment, a simple serial port such as, I²C, can be used. In one embodiment, processing unit 204 is a graphics processing unit (GPU) and is responsible for handling graphics data and rendering graphics data for output on outputs(s) 208 to display device(s) 210. In one embodiment, input device 202 may be used to change or restore a render capable output resolution of graphics data by processing unit 204 which is displayed on display device(s) 210. For example, if the user sets a resolution that is too high or exceeds the capabilities of display device(s) 210, display device(s) 210 may show nothing or corrupted or incomprehensible images and a user may then use input device 202 to signal processing unit 204 that the resolution needs to be restored to a display capable resolution that allows the user to select a display capable resolution for display device(s) 210.

In one embodiment, a button on input device 202 will directly (e.g., button on a chassis) or indirectly (e.g., button on remote control) signal the processing unit 204 that a display capable resolution needs to be restored. In response to the signal from input device 202, processing unit 204 may signal a graphics driver executing on processing unit 206 which signals an output configuration application to modify output settings to display device(s) 210. In one embodiment, output(s) 208 may be connected to a single display device (e.g., one of display device(s) 210) and when the output settings are changed the output connector which a signal is sent out over is changed. In one embodiment, the output may be changed to a lower resolution output and/or analog output to ensure the video signal is now visible.

The changes in output settings may be performed by the output configuration application signaling the operating system to change the output settings. In one embodiment, the output configuration application may signal the operating system to change output settings via an application programming interface (API). Because the output setting modifications are carried out by the operating system, embodiments of the present invention can operate on a wide variety of computing systems for which an operating system compatible graphics driver is available. Thus, embodiments of the present invention restore output of a render capable resolution without requiring specific hardware and therefore are hardware independent.

Processing unit 206 may be coupled to processing unit 204. In one embodiment, processing unit 206 may execute a graphics driver for controlling a plurality of functions and operations of processing unit 204 and may execute an application for changing a plurality of graphics or output settings (e.g., a control panel application).

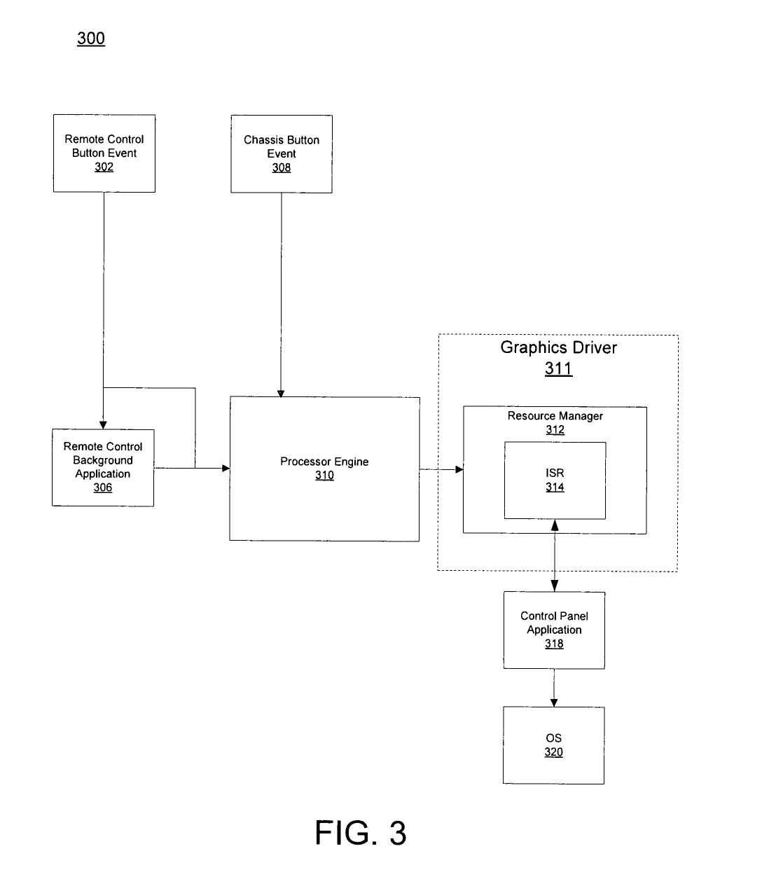

FIG. 3 shows a system 300 for restoring output to a display device in accordance with one embodiment of the present invention. As depicted in FIG. 3, the components 302-320 implement the functionality for restoring a supported output mode for a coupled display device.

The FIG. 3 embodiment illustrates example components or modules that, in various embodiments, are instantiated and executed by a CPU (e.g., CPU 101 of FIG. 1) and/or a GPU (e.g., GPU 110) under the control of computer-readable and computer-executable instructions. However, it should be appreciated that the aforementioned components of system 300 can be implemented in hardware or software or in a combination of both, and that various other components or variations of the components recited in system 300 can be used to implement the functionality of embodiment of the present invention.

In one embodiment, as depicted in FIG. 3, system 300 includes remote control event 302, remote control background application 306, chassis button event 308, a processor engine 310 (e.g., as executed by hardware/software of a GPU), control panel application 318, and graphics driver 311 which includes resource manager 312, interrupt service routine (ISR) 314, and operating system 320.

Processor engine 310 may receive signals from chassis button event 308 and remote control button event 302. The signals regarding the remote control button event 302 are received via remote control background application 306. It is appreciated that processor engine 310 may receive signals via other buttons and interfaces with the same signal being issued to processor engine 310. For example, the signal may be received via a universal serial bus (USB) connection, an infrared receiver, or radio frequency (RF) receiver.

After a user has changed the output resolution, the output of a coupled display device (e.g., display 112) may be blank, corrupted, or otherwise incomprehensible video. The user may then press a remote control button to create a remote control button event 302 or press a chassis button to create a chassis button event 308 to begin the process of restoring display intelligibility (e.g., the lowest common denominator resolution). In one embodiment, the remote control button event 302 may send a signal to the remote control background application 306 or processor engine 310. For example, the user presses a remote control button which sends an IR signal to an IR receiver connected to a USB port of the computer system, a 1394 port, etc., and this signal may be relayed to the remote control background application 306 or processor engine 310. In one embodiment, remote control background application 306 may be executed by a central processing unit (CPU). Remote control background application 306 signal may processor engine 310 that a display capable resolution needs to be restored.

Processing engine 310 may then signal resource manager 312 that the output needs to be changed to a display capable resolution. In one embodiment, processing engine 310 generates an interrupt which is handled by interrupt service request module 314 which is part of resource manager 312. Resource manager 312 may be part of a graphics driver 311 which runs in protected or kernel mode of an operating system. As part of handling the interrupt, interrupt service request module 314 may signal control panel application 318 to change output settings (e.g., resolution or surface size) to restore output to a compatible output mode.

Control panel application 318 may be used to change various output settings and provide a prompt to a user to verify that the new output settings work and output to a display device is comprehensible. If user cannot or does not verify that the output settings work, a timeout may occur and control panel application 318 may signal ISR 314 to restore previous output settings. Control panel application 318 may further be launched when the system starts up and remain in the background or otherwise be hidden and when ISR 314 signals control panel application 318, control panel application 318 may become visible. Control panel application 318 may display or reflect the current resolution or output timing on the graphics settings page or window. For example, if the output timings were changed to 480i, control panel application 318 may have the resolution setting corresponding to 480i selected. In another embodiment, the user may be presented with a message or wizard informing the user that the render capable resolution has been restored and he/she may now attempt to change it again.

In one embodiment, control panel application 318 may signal operating system 320 via an application programming interface (API) to change the resolution to a lowest common denominator resolution (e.g., 480i). In one embodiment, the output settings may be changed (e.g., resolution increased) upon each successive request to restore output to a render capable resolution.

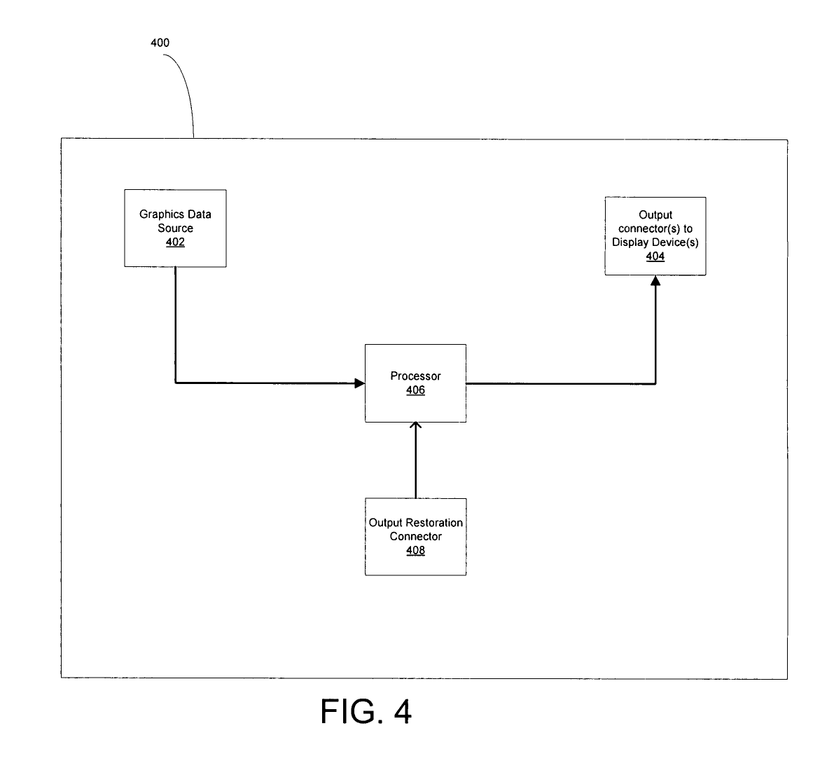

FIG. 4 shows exemplary graphics processing unit 400 in accordance with one embodiment of the present invention. Processor 400 includes graphics data source 402, output connector(s) to display device(s) 404, processor 406, output restoration connector 408. Graphics data source 402 may provide graphics data from a plurality of sources including, but not limited to, DVDs, HD DVDs, Blu-ray DVDs, TV tuners, digital movies (e.g., MPEG2, MPEG4), cable boxes, and satellite receivers.

Processor 406 receives graphics data from graphics data source 402 and renders the data for output to output connector(s) to display device(s) 404. Processor 406 also receives signals from output restoration connector 408. The signals may result from a user setting a resolution which exceeds the capabilities of a display device and then pressing a “panic” or output restoration button. As described herein, the signal may be received by a variety of connections. For example, output restoration connector 408 may be coupled to processor 406 via a GPIO (General Purpose Input Output) connector. In response to a signal from output restoration connector 408, processor 406 generates an interrupt which is handled by a graphics driver (e.g., graphics driver 311) and invokes a change in output settings via an output configuration application (e.g., control panel application 318). After output settings have been modified to a compatible output mode, processor 406 may restart rendering of graphics data. In one embodiment, the output to a compatible output mode can have a changeable output connector.

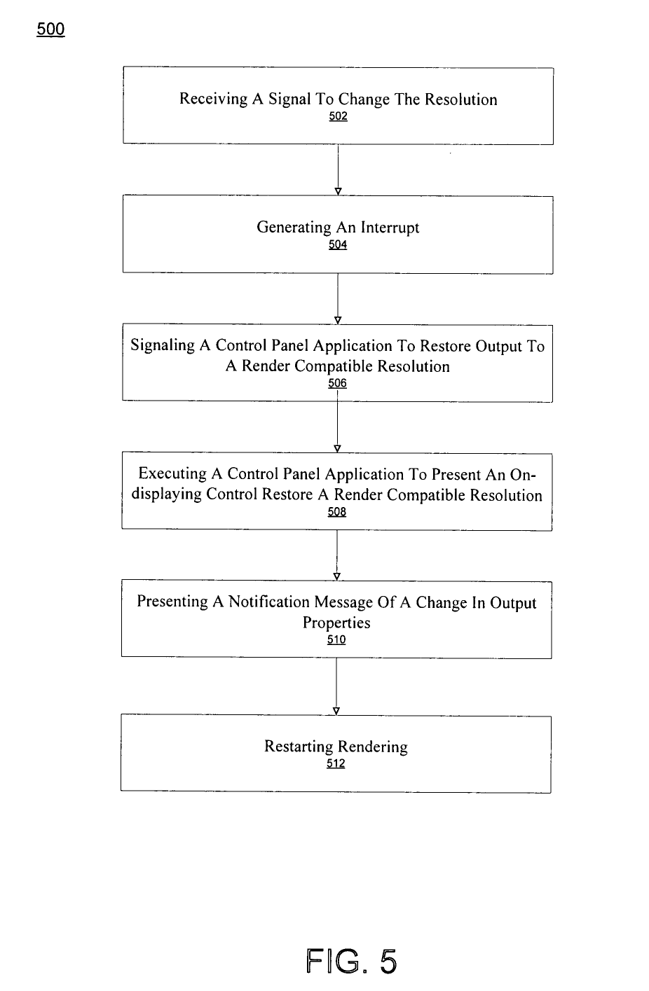

The following discussion sets forth in detail the operations of the present technology for network communication management. With reference to FIGS. 5, flowchart 500 illustrates example blocks used by various embodiments of the present technology. Flowchart 500 includes processes that, in various embodiments, are carried out by a processor under the control of computer-readable and computer-executable instructions. Although, specific blocks are disclosed in flowchart 500, such blocks are examples. That is, embodiments are well suited to performing various other blocks or variations of the blocks recited in flowchart 500. It is appreciated that the blocks in flowchart 500 may be performed in an order different than presented, and that not all of the blocks in flowchart 500 may be performed.

FIG. 5 shows a flowchart 500 of a process for modifying output so that the output is visible on a display device in accordance with one embodiment of the present invention.

At block 502, a request is received to restore the output. The request may have been received via plurality of input devices as described herein such as a remote control or a button on system chassis. The request may have been issued by a user after changing the resolution settings such that the resolution settings exceeded the capabilities of the display device such that the output of the display device is blank, corrupted, or otherwise incomprehensible.

At block 504, an interrupt is generated. In one embodiment, a processor (e.g., GPU) generates an interrupt which will be serviced by an interrupt service routine which is part of a resource manager of a graphics driver as described herein.

At block 506, a control panel application is signaled to restore output to a render capable resolution. The control panel application may be signaled by an interrupt service routine portion of a graphics driver as described herein. In one embodiment, the control panel application may signal an operating system via an operating system API to change the resolution or surface size to a render capable resolution or surface size.

At block 508, a control panel function is executed to present an on-display control for adjusting output settings. The control panel application may be running in the background (e.g., invisible) prior to being invoked and thus becomes visible (upon becoming invoked). The output configuration application may be running as the user had just used the output configuration application to set output settings which exceeded the capabilities of the display device. The output configuration application may further reflect the current output settings (e.g., resolution).

At block 510, a notification message of a change in output properties is presented. A visual notification window, wizard, or other messaging means may be presented to a user via a graphical user interface indicating the output settings have been change in response to a request to change the resolution as described herein. In one embodiment, the notification message may be a control panel application message.

At block 512, rendering is restarted. As described herein, after a change in output settings (e.g., resolution or surface size), the rendering of graphics data (e.g., by processor 406) is restarted with the new output settings.

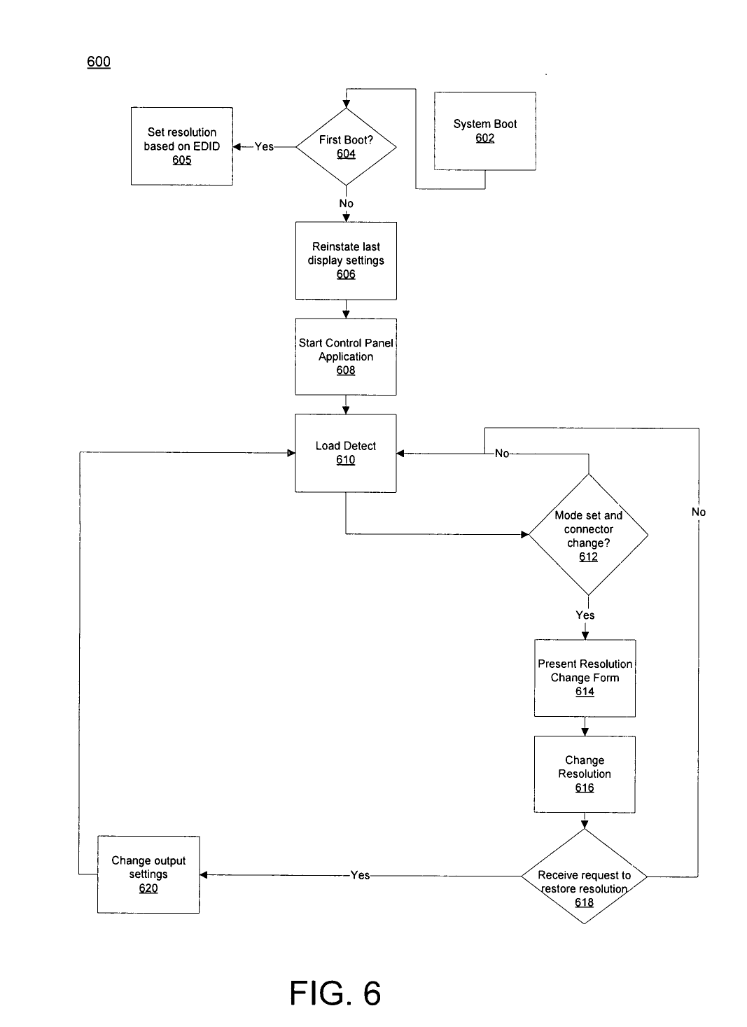

FIG. 6 shows a flowchart 600 of a process for operating a system in accordance with one embodiment of the present invention.

At block 602, a system is booted. The system may be computing system which has multimedia capabilities and is connected to a display device that has been restarted or booted from a turned off state.

At block 604, a check if this is the first boot of the system is performed. First boot information may be stored on a storage device (e.g., hard drive) within the computing system.

At block 605, the resolution is set based on EDID. During the first boot, output settings such as resolution may be set based on the EDID which provides information on the capabilities of a display device.

At block 606, the last or previous display or output settings are reinstated. When the boot sequence is determined to be other than a first boot, previous display settings may be applied.

At block 608, a control panel application is started. As described herein, the control panel application may facilitate setting of various graphics output settings. The control panel application may be started in a background or hidden mode and thus be ready to be invoked (e.g., by an interrupt service routine).

At block 610, load detection is performed. The load (e.g., electrical) may be detected on each output interface. For example, an HDMI and composite connection may be detected. During load detection, extended display identification data (EDID) may be received which describes the capabilities of a display device.

At block 612, a check if there is a change to the mode setting or connectors is performed. If the user changed the resolution or output connector, then block 614 is performed. If there was no change of resolution by the user, then load detection at block 606 is performed.

At block 614, a resolution change form is presented. The resolution change form may be part of a output configuration or control panel application as described herein.

At block 616, the resolution is changed. A resolution change is applied after being selected by a user within an output configuration tool which may exceed the capabilities of the display device.

At block 618, a check is made if a request to restore output is made. The request may have been made via a remote control button or chassis button as described herein by a user in response to a resolution change which resulted in output of a display device being incomprehensible.

At block 620, output settings are changed. The output settings may be modified via signaling a control panel application as described herein, so that output of a display device is restored to a state where a user can utilize a control panel application to set the resolution and other graphics settings more appropriately tailored to the capabilities of the display device.

The foregoing descriptions of specific embodiments of the present invention have been presented for purposes of illustration and description. They are not intended to be exhaustive or to limit the invention to the precise forms disclosed, and many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A method for restoring an output mode of a display output for a display, comprising:
receiving a signal to change a resolution of the display output that drives the display;
generating an interrupt for a display driver executing on a computer system, the display driver configured to control a display processor of the computer system;
signaling a control panel application to restore the resolution of the display output to a compatible output mode for driving the display; and
executing a control panel application to present an on-display control for changing the output mode.

2. The method of claim 1 further comprising:
presenting a notification message of a change in output properties.

3. The method of claim 1 wherein said notification message is a control panel message.

4. The method of claim 1 wherein said control panel application is invoked by an application programming interface (API).

5. The method of claim 4 wherein said API is an operating system API.

6. The method of claim 1 further comprising:
restarting rendering after a render capable resolution is restored.

7. The method of claim 1 wherein said control panel restores output to a compatible output mode by changing the resolution.

8. The method of claim 1 wherein said control panel restores output to a compatible output mode by changing the surface size.

9. A system for outputting graphics, comprising:
a first processor for handling graphics processing and graphics output on said plurality of output connectors wherein said first processor comprises a plurality of connectors;
a plurality of output connectors coupled to said first processor for coupling a plurality of display devices;
a second processor for executing a display driver for controlling a plurality of functions of said first processor and an application for changing a plurality of graphics settings; and
a input device communicatively coupled to at least one of said plurality of connectors of said first processor for invoking a change in output settings so said graphics output is viewable on at least one of said plurality of display devices coupled to al: least one of said plurality of output connectors.

10. The system of claim 9 wherein said first processor is a GPU (graphics processing unit).

11. The system of claim 9 wherein said input device is a remote control.

12. The system of claim 9 wherein said input device is a button coupled to a system chassis.

13. The system of claim 9 wherein said input device is communicatively coupled via universal serial bus (USB).

14. The system of claim 9 wherein said input device is communicatively coupled via an infrared receiver.

15. The system of claim 9 wherein said input device is communicatively coupled via a radio frequency (RF) receiver.

16. The system of claim 9 wherein said input device changes the output settings on each successive request.

17. A GPU (graphics processor unit) comprising:
a processor for rendering graphics data;
a graphics data source for receiving graphics data from a graphics content source;
a plurality of output connectors operable to drive a plurality of display device(s); and
a connector for receiving a signal to restore the output to a compatible output mode wherein said processor generates an interrupt to facilitate restoration of a render capable resolution in response to a signal on said connector.

18. The GPU of claim 17 wherein output to a compatible output mode has a changeable output connector.

19. The GPU of claim 17 wherein said processor restarts rendering after output settings have been changed.

20. The GPU of claim 17 wherein said connector is a GPIO (General Purpose Input Output) connector.
